(19) United States
(12) Patent Application Publication
(10) Pub. No.: US 2021/0399295 A1
(43) Pub. Date: Dec. 23, 2021

(54) Lithium Secondary Battery and Manufacturing Method Thereof

(71) Applicant: Nippon Telegraph and Telephone Corporation, Tokyo (JP)

(72) Inventors: Hironobu Minowa, Musashino-shi, Tokyo (JP); Yoko Ono, Musashino-shi, Tokyo (JP); Shuhei Sakamoto, Musashino-shi, Tokyo (JP); Takeshi Komatsu, Musashino-shi, Tokyo (JP)

(21) Appl. No.: 17/288,439

(22) PCT Filed: Nov. 6, 2019
(86) PCT No.: PCT/JP2019/043533

§ 371 Date: Apr. 23, 2021

(30) Foreign Application Priority Data
Nov. 20, 2018 (JP) 2018-217084

(51) Int. Cl. H01M 4/485; H01M 10/0564; H01M 10/0585; H01M 4/131; H01M 4/1391; H01M 4/505; H01M 4/525; H01M 4/58; H01M 10/0525

(52) U.S. Cl. CPC H01M 4/485; H01M 10/0564; H01M 10/0585; H01M 4/131; H01M 10/0525; H01M 4/505; H01M 4/525; H01M 4/58; H01M 4/1391

(57) ABSTRACT

Provided is a lithium secondary battery having both visible light transparency and flexibility. A lithium secondary battery includes: a positive electrode film formed on a flexible transparent film substrate and capable of intercalating and deintercalating lithium ions; a transparent electrolyte having lithium ion conductivity; and a negative electrode film formed on a flexible transparent film substrate, the negative electrode film being a metal capable of forming an alloy with lithium or capable of intercalating and deintercalating lithium ions. When the positive electrode film contains a lithium source, the negative electrode film is made to have a thickness of 50 nm to 300 nm by using, as a negative electrode material, any of tin oxide, silicon oxide, titanium oxide, tungsten oxide, niobium oxide, molybdenum oxide, metal phosphide, metal sulfide, metal nitride, metal fluoride, or metal titanium composite oxide.

### TECHNICAL FIELD

The present invention relates to a lithium secondary battery and a method for manufacturing the same.

### BACKGROUND ART

A lithium-ion secondary battery using intercalation and deintercalation reactions of lithium ions is in wide use in various applications such as electronic devices, power sources for automobiles, and power storage as a secondary battery having a high energy density. For the purpose of improving the performance and reducing the cost, the research and development of the electrode material and electrolyte material of the lithium-ion secondary battery have been advanced.

Recently, with the development of information technology (IT) devices such as smartphones and internet-of-things (IoT) devices, lithium secondary batteries for mobile power supply have attracted attention. With a view to differentiating the respective products, batteries for such devices may be required to have new characteristics. As the new characteristics, for example, flexibility and the like have emerged.

A battery having flexibility has been reported in, for example, Non-Patent Literature 1. The battery has been reported to be thin and bendable and exhibit a discharge capacity of about 250 μAh/g at a discharge current with a current density of 0.1 mA/cm².

### CITATION LIST

### Non-Patent Literature

Non-Patent Literature 1: Masahiko Hayashi, et al., “Preparation and electrochemical properties of purelithium cobalt oxide films by electron cyclotronresonance sputtering”, Journal of Power Sources 189 (2009) pp. 416-422

### SUMMARY OF THE INVENTION

### Technical Problem

Studies have been made on a lithium secondary battery that is thin and bendable as described above. However, there has been no report on a battery that transmits visible light up to now. That is, when a battery having visible light transparency and flexibility can be achieved, it is possible to greatly expand the ranges of design and applications of IoT devices, but the problem is that such a battery does not exist.

An object of the present invention, which has been made in view of the problem, is to provide a lithium secondary battery having both visible light transparency and flexibility and to provide a method for manufacturing the lithium secondary battery.

### Means for Solving the Problem

A lithium secondary battery according to one aspect of the present invention includes: a positive electrode film that contains a material formed on a flexible transparent film substrate, the material being capable of intercalating and deintercalating lithium ions; a transparent electrolyte having lithium ion conductivity; and a negative electrode film that is formed of a material formed on a flexible transparent film substrate, the material being capable of dissolving and depositing lithium or intercalating and deintercalating lithium ions.

A method for manufacturing a lithium secondary battery according to one aspect of the present invention is a method for manufacturing a lithium secondary battery, the method including: a positive electrode film formation step of forming a positive electrode film that contains a material formed on a flexible transparent film substrate, the material being capable of intercalating and deintercalating lithium ions; an electrolyte formation step of forming a transparent electrolyte that has lithium ion conductivity; and a negative electrode film formation step of forming a negative electrode film that is formed of a material formed on a flexible transparent film substrate, the material being capable of dissolving and depositing lithium or intercalating and deintercalating lithium ions. In the positive electrode film formation step and the negative electrode film formation step, heat treatment is performed at 70° C. to 200° C. in an argon atmosphere after the formation of the electrode film.

### EFFECTS OF THE INVENTION

According to the present invention, it is possible to provide a lithium secondary battery having both visible light transparency and flexibility and to provide a method for manufacturing the lithium secondary battery.

### BRIEF DESCRIPTION OF DRAWINGS

FIG. 1 is a schematic view showing a basic configuration of a lithium secondary battery according to the present embodiment.

FIG. 2 is a flowchart showing a procedure for manufacturing the lithium secondary battery shown in FIG. 1.

FIG. 3 is a diagram showing an example of charge/discharge characteristics of the lithium secondary battery shown in FIG. 1.

FIG. 4 is a diagram showing an example of a charge cycle characteristic of the lithium secondary battery shown in FIG. 1.

FIG. 5 is a diagram showing an example of light transmission characteristics of the lithium secondary battery shown in FIG. 1.

FIG. 6 is a diagram schematically showing how flexibility is evaluated.

FIG. 7 is a diagram showing light transmission characteristics of a lithium secondary battery of Comparative Example 2.

### DESCRIPTION OF EMBODIMENTS

Hereinafter, an embodiment of the present invention will be described with reference to the drawings.

### Structure of Lithium Secondary Battery

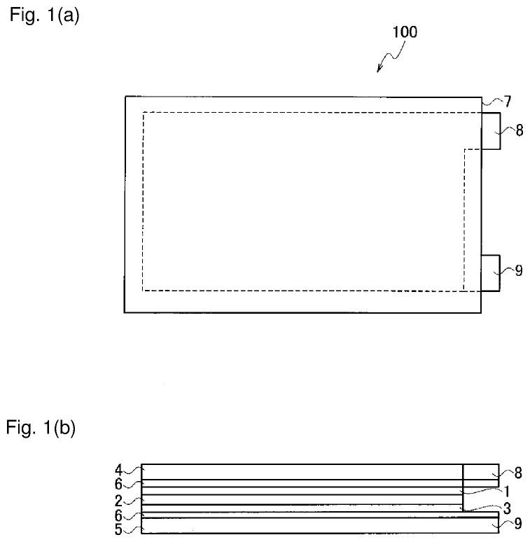

FIG. 1 is a schematic view showing a basic configuration of a lithium secondary battery according to the present embodiment. FIG. 1(a) is a plan view, and FIG. 1(b) is a side view.

As shown in FIG. 1, a lithium secondary battery 100 according to the present embodiment is, for example, a rectangular flat plate and formed by vertically placing a flexible transparent film substrate 4 that has visible light transparency between laminate films 7 and subjecting the laminate films 7 to thermocompression bonding. A positive electrode, an electrolyte, and a negative electrode are disposed between the laminate films 7. Note that the planar shape of the lithium secondary battery 100 is not limited to the rectangular shape.

As shown in FIG. 1(a), a positive electrode terminal 8 and a negative electrode terminal 9 each having a square plane protrude from both ends of one short side of the rectangular film 4 to the outside of the laminate film 7. A current can be taken out from between the positive electrode terminal 8 and the negative electrode terminal 9. The positive electrode terminal 8 and the negative electrode terminal 9 both may be an extension of a transparent electrode film to be described later or may be formed of a metal.

As shown in FIG. 1(b), the lithium secondary battery 100 includes a positive electrode film 1, an electrolyte 2, and a negative electrode film 3. The positive electrode film 1 is formed by forming a film of a material capable of intercalating and deintercalating lithium ions, with a predetermined thickness on a transparent electrode film 6 of indium tin oxide (ITO) or the like formed all over one surface of the flexible transparent film substrate 4.

In the same manner as the positive electrode film 1, the negative electrode film 3 is formed by forming a film of a material capable of intercalating and deintercalating lithium ions, with a predetermined thickness on a transparent electrode film 6 of ITO or the like formed all over one surface of the transparent film substrate 5. The transparent film substrates 4, are identical and made of, for example, polyethylene terephthalate (PET) or the like.

The positive electrode film 1 and the negative electrode film 3 are disposed to face each other with the electrolyte 2 therebetween. As the electrolyte 2, an organic electrolyte or an aqueous electrolyte containing lithium ions can be used so long as being a conventional material having lithium ion conductivity as well as a material having no electronic conductivity and having visible light transparency.

In addition, a conventional solid electrolyte containing lithium ions and a solid-state electrolyte such as a polymer electrolyte can also be used so long as transmitting visible light.

Note that a separator (not shown) may be included between the positive electrode film 1 and the negative electrode film 3. Examples of the separator having light transparency include polyethylene (PE), polypropylene (PP), and an ion-exchange membrane. In a case where the organic electrolyte or the aqueous electrolyte is used as the electrolyte, for example, the separator may be impregnated with the electrolyte.

The organic electrolyte or the aqueous electrolyte may be impregnated with a polymer electrolyte or the like. In a case where the solid electrolyte, the polymer electrolyte, and the like are used, both electrodes may be disposed to be in contact with these electrolytes.

As described above, the lithium secondary battery 100 according to the present embodiment includes the positive electrode film 1, the transparent electrolyte 2 having lithium ion conductivity, and the negative electrode film 3. Here, the positive electrode film 1 contains a material capable of intercalating and deintercalating lithium ions formed on the flexible transparent film substrate 4. The negative electrode film 3 is formed of a material capable of dissolving and depositing lithium or intercalating and deintercalating lithium ions formed on the flexible transparent film substrate 5.

Therefore, it is possible to provide a lithium secondary battery having both visible light transparency and flexibility.

(Method for Manufacturing Lithium Secondary Battery)

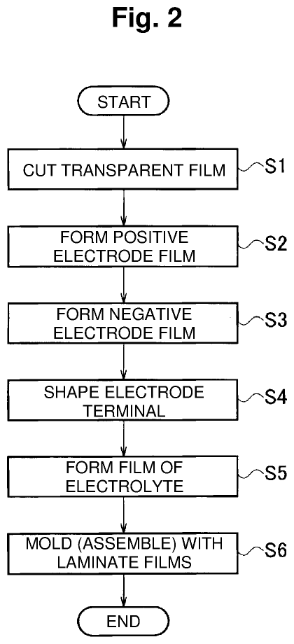

FIG. 2 is a flowchart showing a procedure for manufacturing the lithium secondary battery 100 according to the present embodiment. A method for manufacturing the lithium secondary battery 100 will be described with reference to FIG. 2.

First, each of transparent film substrates 4, 5 (hereinafter, reference numeral 5 is omitted) to be a substrate on which an electrode film is formed is cut into a predetermined size (step S1). The size of the transparent film substrate 4 is, for example, about 100 mm in length×50 mm in width. The thickness thereof is, for example, about 0.1 mm.

Next, a positive electrode film 1 is formed (step S2). In the formation of the positive electrode film 1, a transparent electrode film 6 is formed on the surface of the transparent film substrate 4.

The transparent electrode film 6 was coated with ITO to have a thickness of 150 nm by radio frequency (RF) sputtering method. Sputtering was performed using an ITO (5 wt % SnO₂) target with an RF output of 100 W while argon (1.0 Pa) was allowed to flow.

Subsequently, for example, a film of lithium cobaltate (LiCoO₂) was formed on the transparent electrode film 6 by RF sputtering method to have a thickness of 100 nm. The positive electrode film 1 was formed using a ceramic target of LiCoO₂ with a flow partial pressure ratio of argon to oxygen of 3:1 and a total gas thickness of 3.7 Pa in a condition of an RF output of 600 W.

Next, a negative electrode film 3 is formed (step S3). The negative electrode film 3 is formed by the RF sputtering method in the same manner as the positive electrode film 1. The negative electrode film 3 is formed using a lithium titanate (Li₄Ti₅O₁₂) target with a flow partial pressure ratio of argon to oxygen of 3:1 and a total gas pressure of 4.0 Pa at an RF output of 700 W.

The sizes of the positive electrode film 1 and the negative electrode film 3 are the same, for example, 90 mm in length×50 mm in width. The size of each electrode film is smaller than that of the transparent electrode film 6.

Subsequently, an electrode terminal is shaped (step S4). In each electrode film formed as described above, there is left a part where the electrode film (1, 3) is not formed in an area of a 10 mm in length×a 50 mm in width, and ITO is exposed. In the part, a portion of 10 mm in height×40 mm in width is cut out while a portion of 10 mm in height×10 mm in width is remained, to form a positive electrode terminal 8 and a negative electrode terminal 9.

Then, a film of an electrolyte is formed (step S4). An electrolyte 2 having a transparent film with a thickness of 1 μm was produced by a process as follows. The process as follows is a process in which a solution as follows is stirred at 60° C. for one hour in dry air having a dew point of −50° C. or less, 50 ml of the solution is poured into a 200-mmφ petri dish, which is then vacuum-dried at 50° C. for twelve hours. Here, the solution as follows is a solution obtained by mixing polyvinylidene fluoride (PVdF) powder as a binder, an organic electrolyte, and N-methyl-2 pyrrolidone (NMP) as a dispersion medium at a weight ratio of 1:9:10. Here, the organic electrolyte is an organic electrolyte obtained by dissolving 1 mol/L of lithium bis(trifluoromethanesulfonyl)imide (LiTFSI) as a lithium salt in propylene carbonate (PC).

Next, a battery is assembled (step S6). The transparent film substrate 4 formed with the positive electrode film 1, the transparent film substrate 5 formed with the negative electrode film 3, and the electrolyte 2 are laminated with the positive electrode film 1 and the negative electrode film 3 facing each other across the electrolyte 2. The positive electrode terminal 8 and the negative electrode terminal 9 are then put between the laminate films 7 of a 110 mm in length×a 70 mm in width×a 100 μm in thickness so as to be exposed to the outside, and hot-pressed at 130° C. The thickness of the hot-pressed battery is, for example, about 421 μm.

The lithium secondary battery 100 can be manufactured by the above process.

(Charge/Discharge Test

The charge/discharge characteristics of the lithium secondary battery 100 produced by the above manufacturing method were measured. A charge/discharge test was conducted using a general charge/discharge system. Charge conditions were that a current was applied at a current density of 1 μA/cm² per effective area of the positive electrode film 1, and that a charge termination voltage was set to 2.3 V.

Discharge conditions were that discharge was performed at a current density of 1 μA/cm², and that a discharge termination voltage was set to 1.0 V. The charge/discharge test was conducted in a thermostatic chamber at 25° C. (an atmosphere being left in a normal atmospheric environment).

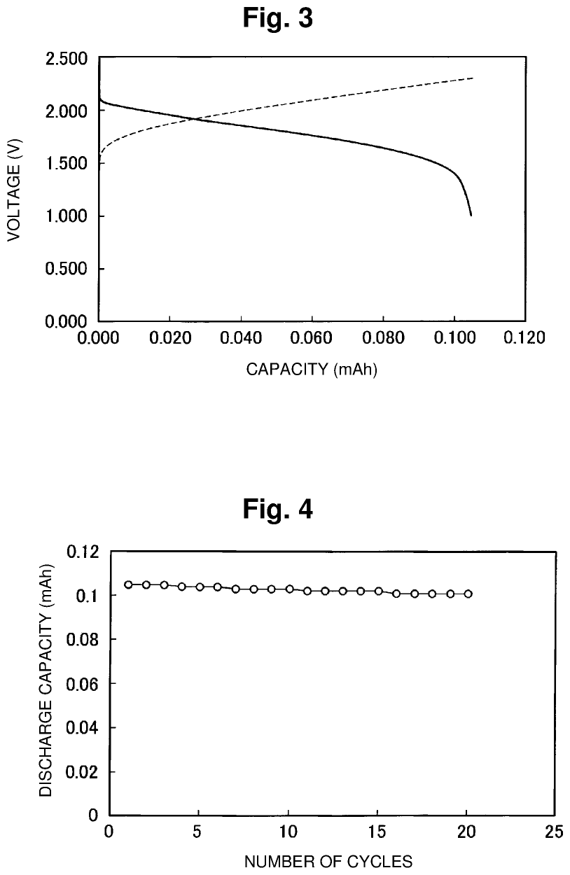

FIG. 3 is a diagram showing charge/discharge characteristics of the lithium secondary battery 100. The horizontal axis of FIG. 3 represents a capacity [mAh], and the vertical axis thereof represents a battery voltage [V]. In FIG. 3, a broken line indicates a charging characteristic, and a solid line indicates a discharging characteristic.

As shown in FIG. 3, an irreversible capacity, which is the difference between the charge capacity and the discharge capacity, is small. The capacity was about 0.105 mAh, and the average discharge voltage was about 1.9 V.

FIG. 4 is a diagram showing a charge cycle characteristic of the lithium secondary battery 100. The horizontal axis of FIG. 4 represents the number of cycles [times] of charge/discharge cycles, and the vertical axis thereof represents the discharge capacity [mAh].

As shown in FIG. 4, a decrease in discharge capacity after cycles is only about 0.004 mAh, and it can be seen that the lithium secondary battery 100 has a stable charge cycle characteristic.

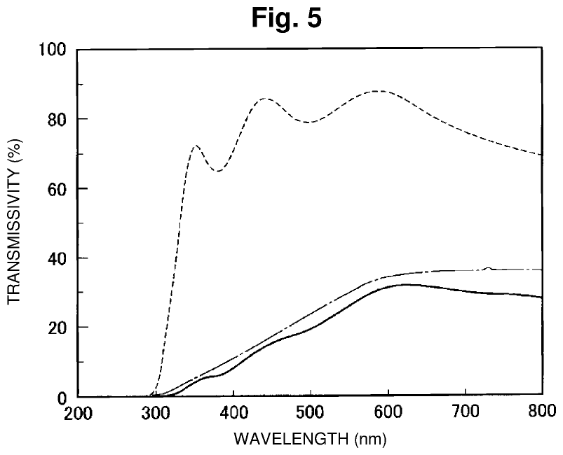

FIG. 5 is a diagram showing light transmission characteristics of the lithium secondary battery 100. The horizontal axis of FIG. 5 represents a light wavelength [nm], and the vertical axis thereof represents a light transmissivity [%]. In FIG. 5, a broken line indicates the light transmission characteristic of the transparent film substrate 5 including the negative electrode film 3. A dashed-dotted line indicates the light transmission characteristic of the film plate 4 including the positive electrode film 1. A solid line indicates the light transmission characteristic of the entire lithium secondary battery 100.

As shown in FIG. 5, the lithium secondary battery 100 as a whole transmits light in the wavelength range (about 380 nm to 780 nm) of visible light. At a wavelength of 600 nm, about 30% of light is transmitted.

As thus described, the lithium secondary battery 100 according to the present embodiment has a stable charge cycle characteristic and light transmission characteristics.

(Experiments)

For the purpose of examining the configuration of the present embodiment described above in detail, experiments were conducted under various conditions of the thickness of the negative electrode film 3, the thickness of the positive electrode film 1, heat treatment, and the like. The results of each experiment will be described.

### EXPERIMENTAL EXAMPLE 1

The negative electrode film 3 was produced with the thickness varied to 30 nm, 50 nm, 200 nm, 300 nm, and 500 nm, and the charge/discharge characteristics were measured. As the active material of the negative electrode film 3, lithium titanate (Li₄Ti₅O₁₂) , which is the same as in the above embodiment, was used. Table 1 shows the results of the experiment. A light transmissivity shown in Table 1 is the transmissivity of the entire battery.

Conditions except for the thickness of the negative electrode film 3 are the same as those in the above embodiment. The active material of the positive electrode film 1 is lithium cobaltate (LiCoO₂), and the thickness thereof is 100 nm.

TABLE 1

| Thickness of | Initial | Discharge | |
|---|---|---|---|
| negative | discharge | capacity in | Light |
| electrode | capacity | 20th cycle | transmissivity |
| film (nm) | (mAh) | (mAh) | (%) |
| 30 | 0.011 | 0.000 | 32.7 |
| 50 | 0.067 | 0.064 | 28.8 |
| 100 | 0.105 | 0.101 | 25.3 |
| 200 | 0.153 | 0.149 | 22.9 |
| 300 | 0.088 | 0.081 | 20.8 |
| 500 | 0.023 | 0.020 | 17.4 |

As shown in Table 1, when the thickness of the negative electrode film 3 was 200 nm, the largest discharge capacity was shown. This is considered to be because the amount of lithium titanate (Li₄Ti₅O₁₂), which is the negative electrode active material, was equal to or more than the amount of the positive electrode active material.

When the thickness of the negative electrode film 3 is 500 nm, the discharge capacity decreases. This is considered to be because the resistance in the thickness direction up to the transparent conductive film 6, which is a current collector, increased due to the low electronic conductivity of lithium titanate (Li₄Ti₅O₁₂) itself.

From the results in Table 1, it can be seen that when a capacity of, for example, 0.064 mAh or more is set as an allowable range, the thickness of the negative electrode film 3 is preferably from 50 nm to 300 nm. The capacity of 0.064 mAh or more is a capacity capable of utilizing a power of 1 mW for about five minutes.

A similar result can be obtained even when another negative electrode active material having an electronic conductivity equal to or higher than that of lithium titanate (Li₄Ti₅O₁₂) is used. The negative electrode active material is, for example, any of tin oxide, silicon oxide, titanium oxide, tungsten oxide, niobium oxide, molybdenum oxide, metal sulfide, metal nitride, metal fluoride, and metal titanium composite oxide.

When the positive electrode film 1 contains the lithium source as described above, the negative electrode film 3 is made to have a thickness of 50 nm to 300 nm by using any of tin oxide, silicon oxide, titanium oxide, tungsten oxide, niobium oxide, molybdenum oxide, metal sulfide, metal nitride, metal fluoride, and metal titanium composite oxide. In this way, the capacity of 0.064 mAh or more can be ensured.

Further, as shown in Table 1, even when the thickness of the negative electrode film 3 is varied in the range of 50 nm to 300 nm, the light transmissivity of 20% or more can be ensured.

As other lithium sources to be contained in the positive electrode film 1, the following can be considered: a lithium manganese composite oxide, a lithium nickel composite oxide, a lithium cobalt composite oxide, a lithium nickel cobalt composite oxide, a lithium manganese cobalt composite oxide, a lithium manganese nickel composite oxide, a lithium phosphorus oxide, a lithium nickel cobalt manganese composite oxide, a lithium nickel cobalt aluminum composite oxide, a lithium silicon composite oxide, a lithium boron composite oxide, and the like.

### EXPERIMENTAL EXAMPLE 2

The negative electrode film 3 was produced with the thickness set to 200 nm, which showed the best characteristics in Experimental Example 1, the positive electrode film 1 was produced with the thickness varied to 30 nm, 50 nm, 150 nm, 200 nm, and 300 nm, and the charge/discharge characteristics were measured. Table 2 shows the results of the experiment.

TABLE 2

| Thickness of | Initial | Discharge | |
|---|---|---|---|
| positive | discharge | capacity in | Light |
| electrode | capacity | 20th cycle | transmissivity |
| film (nm) | (mAh) | (mAh) | (%) |
| 30 | 0.042 | 0.037 | 45.5 |
| 50 | 0.087 | 0.083 | 37.8 |
| 100 | 0.153 | 0.149 | 22.9 |
| 150 | 0.218 | 0.214 | 16.5 |
| 200 | 0.187 | 0.181 | 10.1 |
| 300 | 0.073 | 0.070 | 6.5 |

As shown in Table 2, the positive electrode film 1 having a thickness of 150 nm showed the largest discharge capacity. This is considered to be because the amount of lithium cobaltate (LiCoO₂), which is the positive electrode active material, was equal to or more than the amount of the negative electrode active material as in Experimental Example 1.

The thickness of the positive electrode film 1 is preferably from 50 nm to 300 nm, as is the thickness of the negative electrode film 3. In this range, the capacity of 0.064 mAh or more can be ensured. However, the light transmissivity decreases to 10% or less when the thickness of the positive electrode film 1 is 200 nm or more. Therefore, it can be seen that when light transmissivity is also considered, the thickness of the positive electrode film 1 is preferably from 50 nm to 150 nm.

A similar result can be obtained even when another negative electrode active material having an electronic conductivity equal to or higher than that of lithium cobaltate (LiCoO₂) is used. The negative electrode active material is, for example, any of manganese oxide, iron oxide, copper oxide, nickel oxide, vanadium oxide, metal sulfide, metal sulfate compound, metal phosphate compound, metal fluoride, metal molybdenum composite oxide, metal tungsten composite oxide, and metal cyano complex.

When the negative electrode film 3 contains the lithium source as described above, the positive electrode film 1 is made to have a thickness of 50 nm to 300 nm by using any of manganese oxide, iron oxide, copper oxide, nickel oxide, vanadium oxide, metal sulfide, metal sulfate compound, metal phosphate compound, metal fluoride, metal molybdenum composite oxide, metal tungsten composite oxide, and metal cyano complex. In this way, the capacity of 0.064 mAh or more can be ensured.

Further, as shown in Table 2, even when the thickness of the positive electrode film 1 is varied in the range of 50 nm to 150 nm, the light transmissivity of 15% or more can be ensured.

As other lithium sources to be contained in the negative electrode film 3, lithium metal, lithium alloy, lithium nitride, lithium phosphide, and the like can be considered.

### EXPERIMENTAL EXAMPLE 3

It is known that by heat-treating the electrode film after formed, the surface of the electrode film is cleaned, and the crystallinity thereof is improved. Therefore, an experiment was conducted to compare charge cycle characteristics of lithium secondary batteries each produced by setting the thickness of the negative electrode film 3 to 200 nm and the thickness of the positive electrode film 1 to 150 nm, which showed good characteristics in Experimental Examples 1 and 2, and heat-treating the formed negative electrode film 3 in an argon atmosphere at any temperature of 70° C., 100° C., 200° C., and 300° C. for three hours. Table 3 shows the results of the experiment.

TABLE 3

| Heat-treatment | Initial | Discharge |
|---|---|---|
| temperature of | discharge | capacity in |
| negative electrode | capacity | 20th cycle |
| film (° C.) | (mAh) | (mAh) |
| untreated | 0.218 | 0.214 |
| 70 | 0.220 | 0.216 |
| 100 | 0.222 | 0.218 |
| 200 | 0.222 | 0.219 |
| 300 | — | — |

As shown in Table 3, the battery performance was improved by heat treatment. At 300° C., the transparent film substrate 5 was deformed, and the battery could not be produced.

Table 4 shows the results of performing a similar experiment on the positive electrode film 1.

TABLE 4

| Heat-treatment | Initial | Discharge |
|---|---|---|
| temperature of | discharge | capacity in |
| positive electrode | capacity | 20th cycle |
| film (° C.) | (mAh) | (mAh) |
| untreated | 0.222 | 0.218 |
| 70 | 0.222 | 0.219 |
| 100 | 0.224 | 0.221 |
| 200 | 0.225 | 0.222 |
| 300 | — | — |

As shown in Table 4, a similar heat treatment was applied to the positive electrode film 1 to obtain similar results to those of the negative electrode film 3.

From the results shown in Tables 3 and 4, it was found that the battery performance is improved when the electrode film is formed and then heat-treated for three hours at any temperature within the temperature range of 70° C. to 200° C. It is thus preferable to perform the heat treatment after the formation of the electrode film.

A method for manufacturing a lithium secondary battery 100 according to the present embodiment includes a positive electrode film formation step, an electrolyte formation step, and a negative electrode film formation step. Here, in the positive electrode film formation step, a positive electrode film containing a material capable of intercalating and deintercalating lithium ions formed on a flexible transparent film substrate is formed. In the electrolyte formation step, a transparent electrolyte having lithium ion conductivity is formed. In the negative electrode film formation step, a negative electrode film formed of a material, formed on a flexible transparent film substrate, the material being capable of dissolving and depositing lithium or intercalating and deintercalating lithium ions, is formed. Then, in the positive electrode film formation step and the negative electrode film formation step, after the formation of the electrode film, heat treatment is performed for three hours in an argon atmosphere at any temperature within a temperature range of 70° C. to 200° C. It is thereby possible to improve the performance of the lithium secondary battery 100.

(Surface Roughness of Electrode Film Surface)

In a case where a lithium secondary battery 100 having visible light transparency is achieved, the surface roughness of the electrode film has a great influence on the light transmissivity. That is, while the transparent film substrate 4, the electrolyte 2, and the laminate film 7, which are other components, basically transmit light, the positive electrode film 1 and the negative electrode film 3 do not transmit light. Hence it is considered that when the surface roughness of electrode film surfaces of the positive electrode film 1 and the negative electrode film 3 is large, light is irregularly reflected, and the transmissivity is lowered.

Therefore, an experiment was conducted on the relationship between the surface roughness of the negative electrode film 3 and the positive electrode film 1 and the light transmissivity.

The surface roughness is determined by measuring a surface of 500×500 nm with an atomic force microscope (AFM 5200S manufactured by Hitachi High-Tech Corporation). Table 4 shows the results of the experiment.

In Comparative Example 1 shown in Table 5, the surfaces of the positive electrode film 1 and the negative electrode film 3 produced in the above embodiment are scratched. The scratches were caused by rotating the substrate to which the electrode film was fixed at 10 rpm and bringing a brush, which has a Tylon resin tip with a diameter of about 0.2 mm, into contact with the surface of the electrode film.

TABLE 5

| | Surface | Surface | |
|---|---|---|---|
| | roughness of | roughness of | |
| Heat-treatment | negative | positive | Light |
| temperature | electrode film | electrode film | transmissivity |
| (° C.) | (nm) | (nm) | (%) |
| No heat- | 54.8 | 78.7 | 25.3 |
| treatment | | | |
| 70 | 54.0 | 76.9 | 25.7 |
| 100 | 52.1 | 74.1 | 26.8 |
| 200 | 49.9 | 70.4 | 28.4 |
| Comparative | 69.5 | 138.3 | 13.5 |
| Example 1 | | | |

As shown in Table 5, it can be seen that the surface of the electrode film is smoothed by performing heat treatment after the formation of the electrode film. The light transmissivity improves as the surface roughness decreases.

From the results shown in Table 5, it can be seen that a transmissivity of 20% or more can be obtained when the surface roughness of the negative electrode film 3 is 60 nm or less and the surface roughness of the positive electrode film is 80 nm or less, even without heat treatment.

(Flexibility)

The flexibility of the lithium secondary battery 100 according to the present embodiment was examined.

A load is vertically applied downward to the central portion of the battery with both ends of the battery as a fulcrum to evaluate the flexibility based on the relationship between the amount of bend of the lithium secondary battery 100 and the load.

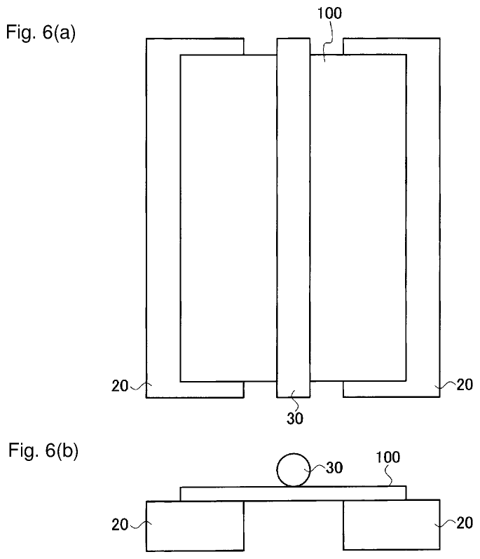

FIG. 6 is a diagram schematically showing how flexibility is evaluated. FIG. 5(a) is a plan view, and FIG. 5(b) is a side view. Metal supports 20 each having a height of 15 mm were installed with a space of 30 mm therebetween, the lithium secondary battery 100 (battery) was stretched over the metal supports 20, a metal rod 30 having a weight of 200 g and a diameter of 10 mm was placed in the center of the battery, and the weight of the load, which was applied to the metal rod 30 until the back surface of the battery comes into contact with the plane where the metal supports 20 were installed, was used as an index of flexibility.

Batteries in which the thicknesses of the laminate films 7 were 50 μm (battery thickness of 421 μm), 100 μm (battery thickness of 523 μm), and 150 μm (battery thickness of 625 μm) were produced, and the flexibility was evaluated. Table 6 shows the results of the evaluation. Of each load shown in Table 6, 200 g is the weight of the metal rod 30.

TABLE 6

| Laminate film | Battery | Load |
|---|---|---|
| thickness (μm) | thickness (μm) | (g) |
| 100 | 421 | 453 |
| 200 | 523 | 588 |
| 300 | 625 | 710 |

As shown in Table 6, the load for bending the battery by a certain amount increases with an increase in the thickness of the battery. As thus described, the flexibility is lost when the thickness of the battery increases.

Assuming that the lithium secondary battery 100 according to the present embodiment is mounted on a wearable device, the flexibility of the battery is considered sufficient when the battery is bent by the amount of bend described above with a load of 500 g, for example. Hence the thickness of the lithium secondary battery 100 is preferably 500 μm or less.

When the thickness of the lithium secondary battery 100 is set to 500 μm or less, the lithium secondary battery 100 can be provided with practically sufficient flexibility in addition to light transparency.

### Comparative Example 2

For the purpose of making comparisons with the above embodiment and experimental examples, a lithium secondary battery of Comparative Example 2 was produced by mixing carbon, which is a conductive assistant, into an electrode film.

The lithium secondary battery of Comparative Example 2 was produced by forming a carbon thin film having a thickness of 20 nm on each of the positive electrode film 1 of lithium cobaltate (LiCoO₂) and the negative electrode film 3 of lithium titanate (Li₄Ti₅O₁₂) having a thickness of 80 nm. The configurations except for this were made the same as those in the above embodiment.

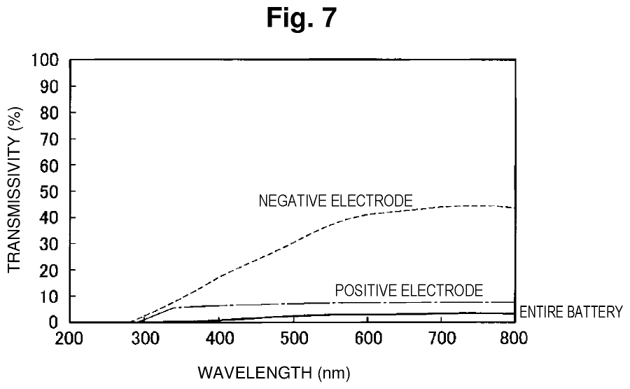

FIG. 7 is a diagram showing light transmission characteristics of Comparative Example 2. The horizontal axis of FIG. 7 represents a light wavelength [nm], and the vertical axis thereof represents a light transmissivity [%]. In FIG. 7, a broken line indicates the light transmission characteristic of the transparent film substrate 5 including the negative electrode film 3. A dashed-dotted line indicates the light transmission characteristic of the film plate 4 including the positive electrode film 1. A solid line indicates the light transmission characteristic of the entire battery of Comparative Example 2.

As shown in FIG. 7, the transmissivity of the entire battery of Comparative Example 2 is 5% or less, and the battery hardly transmits light. The transmissivity of the negative electrode film 3 indicated by a broken line is equal to or less than a half of that in the above embodiment (FIG. 5). It is considered that the reason why the transmissivity of Comparative Example 2 is low like this is that the carbon thin film reflects and absorbs a large amount of light.

By comparing Comparative Example 2 (FIG. 7) with the lithium secondary battery 100 (FIG. 5) according to the present embodiment, it can be clearly seen that the light transmission characteristic of the present embodiment is excellent.

As described above, according to the present invention, it is possible to provide a lithium secondary battery having both visible light transparency and flexibility and to provide a method for manufacturing the lithium secondary battery. Note that the present invention is not limited to the above embodiment but can be modified within the scope of the gist thereof.

### INDUSTRIAL APPLICABILITY

The present embodiment can produce a lithium secondary battery having both visible light transparency and flexibility and can be used as a power source for various electronic devices.

### REFERENCE SIGNS LIST

1 Positive electrode film

2 Electrolyte

3 Negative electrode film

4, 5 Transparent film substrate

6 Transparent electrode film

7 Laminate film

8 Positive electrode terminal

9 Negative electrode terminal

100 Lithium secondary battery

1. A lithium secondary battery comprising:
a positive electrode film that contains a material formed on a flexible transparent film substrate, the material being capable of intercalating and deintercalating lithium ions;
a transparent electrolyte having lithium ion conductivity; and
a negative electrode film that is formed of a material formed on a flexible transparent film substrate, the material being capable of dissolving and depositing lithium or intercalating and deintercalating lithium ions.

2. The lithium secondary battery according to claim 1, wherein when the positive electrode film contains a lithium source, the negative electrode film is made to have a thickness of 50 nm to 300 nm by using, as a negative electrode material, any of tin oxide, silicon oxide, titanium oxide, tungsten oxide, niobium oxide, molybdenum oxide, metal phosphide, metal sulfide, metal nitride, metal fluoride, orand metal titanium composite oxide.

3. The lithium secondary battery according to claim 1, wherein when the negative electrode film contains a lithium source, the positive electrode film is made to have a thickness of 50 nm to 300 nm by using, as a positive electrode material, any of manganese oxide, iron oxide, copper oxide, nickel oxide, vanadium oxide, metal sulfide, metal sulfate compound, metal phosphate compound, metal fluoride, metal molybdenum composite oxide, metal tungsten composite oxide, orand metal cyano complex.

4. The lithium secondary battery according to claim 1, wherein
the positive electrode film has a surface roughness of 60 nm or less, and
the negative electrode film has a surface roughness of 80 nm or less.

5. A method for manufacturing a lithium secondary battery, comprising:
a positive electrode film formation step of forming a positive electrode film that contains a material formed on a flexible transparent film substrate, the material being capable of intercalating and deintercalating lithium ions;
an electrolyte formation step of forming a transparent electrolyte that has lithium ion conductivity; and
a negative electrode film formation step of forming a negative electrode film that is formed of a material formed on a flexible transparent film substrate, the material being capable of dissolving and depositing lithium or intercalating and deintercalating lithium ions,
wherein in the positive electrode film formation step and the negative electrode film formation step, heat treatment is performed at 70° C. to 200° C. in an argon atmosphere after the formation of the electrode film.

6. The lithium secondary battery according to claim 2, wherein
the positive electrode film has a surface roughness of 60 nm or less, and
the negative electrode film has a surface roughness of 80 nm or less.

7. The lithium secondary battery according to claim 3, wherein
the positive electrode film has a surface roughness of 60 nm or less, and
the negative electrode film has a surface roughness of 80 nm or less.
